(19) United States
(12) Patent Application Publication
(10) Pub. No.: US 2014/0318395 A1
(43) Pub. Date: Oct. 30, 2014

(54) SCREEN PRINTING METHOD USING PRINTING INK WHICH REACTS TO FORM A POLYURETHANE POLYMER

(71) Applicants: Ludwig Jenninger, Ahorn-Berolzheim (DE); Maria Jenninger, (US)

(72) Inventors: Werner Jenninger, Koln (DE); Joachim Wagner, Koln (DE); Thomas Bernert, Leverkusen (DE); Dirk Schapeler, Mountain View, CA (US)

(73) Assignee: Bayer Intellectual Property GmbH, 40789 Monheim (DE)

(21) Appl. No.: 14/009,860

(22) PCT Filed: Mar. 28, 2012
(86) PCT No.: PCT/EP2012/055465

§ 371 Date: Dec. 17, 2013

(30) Foreign Application Priority Data
Apr. 13, 2011 (EP) 11162170.2

(51) Int. Cl. B41F 15/08

(52) U.S. Cl. CPC B41F 15/08
USPC 101/129

(57) ABSTRACT

The invention relates to a method for printing objects, comprising the step of application of a printing ink by means of screen printing, wherein the printing ink comprises a polyisocyanate A) and/or a polyisocyanate prepolymer B), an at least difunctional compound C) which is reactive towards isocyanate groups and furthermore a catalyst D) which cap be activated by increasing the temperature. It also relates to the use of a corresponding reaction, mixture as a printing ink in screen printing processes and to an electromechanical converter having a polymer layer produced, by a method according to the invention.

The present invention relates to a method for printing objects, comprising the step of application of a printing ink by means of screen printing, wherein after the screen printing step the printing ink cures to form a polyurethane polymer. It also relates to the use of a corresponding reaction mixture as a printing ink in screen printing processes and to an electromechanical converter having a polymer layer produced by a method according to the invention.

Electromechanical converters have an important part to play in the conversion of electrical energy into mechanical energy and vice versa. Electromechanical converters can therefore be used as sensors, actuators and/or generators.

One class of such converters is based on electroactive polymers. It is an ongoing objective to improve the properties of electroactive polymers, in particular the electrical resistance and the breakdown field strength. At the same time, however, the mechanical properties of the polymers should make them suitable for use in electromechanical converters. Finally, the choice of possible production methods is also important for a successful application.

Examples of electromechanical converters can be found in WO 2001/06575 A1. This patent application relates to converters, their use and their manufacture, Such a converter for converting mechanical energy into electrical energy comprises at least two electrodes and a polymer, The polymer is configured in such a way that a change in length of a first section changes an electrical field. Moreover, a second section of the polymer is elastically pre-tensioned.

Screen printing is a suitable method in principle for producing both thin, two-dimensional elements and fine linear structures. The properties of the elements and structures produced naturally depend on the printing ink used.

EP 1 500 687 A1 describes an ink for screen printing processes wherein the ink produces a roughness and/or thickness on the printed image. The ink described therein is Intended for use in particular in catalogues and printed advertising materials for decorative wall coverings to reproduce the feel of such a covering. The possibility of the ink containing polyurethane hinders is also described. Certain restrictions are imposed here, however, since a cured polyurethane polymer is already present before the printing process. Thus only soluble or dispersible polymers, for example, ears be processed.

U.S. Pat. No. 6,336,666 describes a method for producing a film with a pattern which is intended to prevent duplication by optical scanning. In the production of a film by printing a top layer with a non-glossy surface, a first glossy printed layer adheres to the surface. A second continuous printed layer adheres neither to the top layer nor to the first printed layer. This patent mentions the possibility of screen printing for the printed layers. It also mentions that a two-component mixture can be used for the second printed layer, which mixture polymerises in situ and can form a polyurethane layer in particular. However, this patent makes no comment on the processing times for screen printing.

Regarding processing times there are two factors of significance for a reactive printing ink which cures to form a preferably insoluble polymer network only after screen printing. The pot life of the ready-to-use printing ink should not be too short, so that the processing of the ink is not subject to excessive restrictions. Furthermore, however, the curing time should be short, so that the print result dries quickly and can be processed further.

Against this background the object of the present invention was to provide a method in which a polyurethane polymer is obtained on the printed object and which can be performed with relatively short cycle times.

The object is achieved according to the invention by a method for printing objects, comprising the step of application of a printing ink by means of screen printing, wherein the printing ink comprises
a polyisocyanate A) and/or
a polyisocyanate prepolymer B),
an at least difunctional compound C) which is reactive towards isocyanate groups
and furthermore a catalyst D) which can be activated by increasing the temperature.

Within the meaning of the present invention a “catalyst which can be activated by increasing the temperature” means that its active constituent is only cleaved off and/or released when the temperature is increased.

It has been found that a catalyst which can be activated by increasing the temperature does not restrict the pot life of the printing ink excessively, while at the same time the curing time on exposure to heat is short. This increases the effectiveness of the screen printing process significantly, and an extended group of polyurethanes, in particular polyurethane elastomers, can be obtained as the applied printed image. The heat-activated catalyst offers the advantage of a substantially increased pot life combined with a short reaction time. This results in a longer service life of the screen in a continuous/quasi-continuous printing process and short cycle times in the production plant.

1,4-Butylene diisocyanate, 1,6-hexamethylene diisocyanate (HDI), isophorone diisocyanate (IPDI), 2,2,4- and/or 2,4,4-trimethylhexamethylene diisocyanate, the isomeric bis-(4,4′-isocyanatocyclohexyl)methanes or mixtures thereof with any isomer content, 1,4-cyclohexylene diisocyanate, 4-isocyanatomethyl-1,8-octane diisocyanate (nonane triisocyanate), 1,4-phenylene diisocyanate, 2,4- and/or 2,6-toluylene diisocyanate, 1,5-naphthylene diisocyanate, 2,2′- and/or 2,4′- and/or 4,4′-diphenylmethane diisocyanate, 1,3- and/or 1,4-bis-(2-isocyanatoprop-2-yl)benzene (TMXDI), 1,3-bis(isocyanatomethyl)benzene (XDI), alkyl-2,6-diisocyanatohexanoates (lysine diisocyanates) with alkyl groups having 1 to 8 carbon atoms and mixtures thereof, for example, are suitable as the isocyanates and polyisocyanates A). Furthermore, compounds containing uretdione, isocyanurate, biuret, iminooxadiazinedione or oxadiazinetrione structures and based on the cited diisocyanates are suitable structural units of component A).

Component A) can preferably be a polyisocyanate or a polyisocyanate mixture having an average NCO functionality of 2 to 4 with exclusively aliphatically or cycloaliphatically bonded isocyanate groups. These are preferably polyisocyanates or polyisocyanate mixtures of the aforementioned type having a uretdione, isocyanurate, biuret, iminooxadiazinedione or oxadiazinetrione structure as well as mixtures thereof and an average NCO functionality of the mixture of 2 to 4, preferably 2 to 2.6 and particularly preferably 2 to 2.4.

The polyisocyanate prepolymers which can be used as component B) can be obtained by reacting one or more diisocyanates with one or more hydroxy-functional, in particular polymeric, polyols, optionally with the addition of catalysts as well as auxiliary substances and additives. Furthermore, components for chain extension, such as for example those having primary and/or secondary amino groups (NH₂ and/or NH-functional components), can additionally be used to form the polyisocyanate prepolymer.

The polyisocyanate prepolymer as component B) can preferably be obtainable from the reaction of polymeric polyols and aliphatic diisocyanates. Hydroxy-functional. polymeric polyols for the reaction to form the polyisocyanate prepolymer B) can be for example polyester polyols, polyacrylate polyols, polyurethane polyols. polycarbonate polyols, polyether polyols, polyester polyacrylate polyols, polyurethane polyacrylate polyols, polyurethane polyester polyols, polyurethane polyether polyols, polyurethane polycarbonate polyols and/or polyester polycarbonate polyols. These can be used individually or in any mixtures with one another to produce the polyisocyanate prepolymer.

Suitable polyester polyols for producing the polyisocyanate prepolymers B) can be polycondensates of diols and optionally triols and tetraols and dicarboxylic and optionally tricarboxylic and tetracarboxylic acids or hydroxycarboxylic acids or lactones. In place of the free polycarboxylic acids, the corresponding polycarboxylic anhydrides or corresponding polycarboxylic acid esters of low alcohols can also be used to produce the polyesters.

Examples of suitable diols are ethylene glycol, butylene glycol, diethylene glycol, triethylene glycol, polyalkylene glycols such as polyethylene glycol, also 1,2-propanediol, 1,3-propanediol, butanediol(1,3), butanediol(1,4), hexanediol(1,6) and isomers, neopentyl glycol or hydroxypivalic acid neopentyl glycol ester or mixtures thereof, with hexanediol(1,6) and isomers, butanediol(1,4), neopentyl glycol and hydroxypivalic acid neopentyl glycol ester being preferred. In addition, polyols such as trimethylolpropane, glycerol, erythritol, pentaerythritol, trimethylolbenzene or tris-hydroxyethyl isocyanurate or mixtures thereof can also be used.

Phthalic acid, isophthalic acid, terephthalic acid, tetrahydrophthalic acid, hexahydrophthalic acid, cyclohexane dicarboxylic acid, adipic acid, azelaic acid, sehacic acid, glutaric acid, tetrachlorophthalic acid, maleic acid, fumaric acid, itaconic acid, malonic acid, suberic acid, 2-methyl succinic acid, 3,3-diethyl glutaric acid and/or 2,2-dimethyl succinic acid can be used here as dicarboxylic acids. The corresponding anhydrides can also be used as the acid source.

Provided that the average functionality of the polyol to be esterified is ≧2, monocarboxylic acids, such as benzoic acid and hexanecarboxylic acid, can additionally be incorporated.

Preferred acids are aliphatic or aromatic acids of the aforementioned type. Adipic acid, isophthalic acid and phthalic acid are particularly preferred.

Hydroxycarboxylic acids which can be incorporated as reactants in the production of a polyester polyol having terminal hydroxyl groups are, for example, hydroxycaproic acid, hydroxybutyric acid, hydroxydecanoic acid or hydroxystearic acid or mixtures thereof. Suitable lactones are caprolactone, butyrolactone or homologues or mixtures thereof. Caprolactone is preferred here.

Polycarbonates containing hydroxyl groups, for example polycarbonate polyols, preferably polycarbonate diols, can likewise be used to produce the polyisocyanate prepolymers B). They can have a number-average molecular weight Mₙ of 400 g/mol to 8000 g/mol, for example, preferably 600 g/mol to 3000 g/mol. They can be obtained by reacting carbonic acid derivatives, such as diphenyl carbonate, dimethyl carbonate or phosgene, with polyols, preferably diols.

Examples of diols which are suitable for this purpose are ethylene glycol, 1,2- and 1,3-propanediol, 1,3- and 1,4-butanediol, 1,6-hexanediol, 1,8-octanediol, neopentyl glycol, 1,4-bishydroxymethyl cyclohexane, 2-methyl-1,3-propanediol, 2,2,4-trimethylpentanediol-1,3, dipropylene glycol, polypropylene glycols, dibutylene glycol, polybutylene glycols, bisphenol A or lactone-modified diols of the aforementioned type or mixtures thereof.

The diol component preferably then contains from 40 percent by weight to 100 percent by weight of hexanediol, preferably 1,6-hexanediol and/or hexanediol derivatives, Such hexanediol derivatives are based on hexanediol and can have ester or ether groups in addition to terminal OH groups. Such derivatives are obtainable for example by reacting hexanediol with excess caprolactone or by etherifying hexanediol with itself to form dihexylene or trihexylene glycol. The amount of these and other components is chosen such that the sum does not exceed 100 percent by weight and in particular equals 100 percent by weight.

Polycarbonates having hydroxyl groups, in particular polycarbonate polyols, preferably have a linear structure.

Polyether polyols can likewise be used to produce the polyisocyanate prepolymers B). Polytetramethylene glycol polyethers, such as are obtainable by polymerisation of tetrahydrofuran by cationic ring opening, are suitable for example. Likewise suitable polyether polyols can be the addition products of styrene oxide, ethylene oxide, propylene oxide, butylene oxide and/or epichlorohydrin with diftmctional or polyfunctional starter molecules. Water, butyl diglycol, glycerol, diethylene glycol, trimethyloipropane, propylene glycol, sorbitol, ethylene diamine, triethanolamine or 1,4-butanediol or mixtures thereof, for example, can be used as suitable starter molecules.

Preferred components for producing the polyisocyanate prepoiymers B) are polypropylene glycol, poiytetramethylene glycol polyethers and polycarbonate polyols or mixtures thereof, polypropylene glycol being particularly preferred.

Polymeric polyols having a number-average molecular weight Mn of 400 g/mol to 8000 g/mol, preferably 400 g/mol to 6000 g/mol and particularly preferably 600 g/mol to 3000 g/mol can be used here. These preferably have an OH functionality of 1.5 to 6, particularly preferably 1.8 to 3, most particularly preferably 1.9 to 2.1.

In addition to the cited polymeric polyols, short-chain polyols can also be used in the production of the polyisocyanate prepoiymers B). For example, ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, neopentyl glycol, hydroquinone dihydroxyethyl ether, bisphenol A (2,2-bis(4-hydroxyphenyl)propane), hydrogenated bisphenol A (2,2-bis(4-hydroxycyclohexyl)propane), trimethylolpropane, trimethylolethane, glycerol or pentaeiythritol or a mixture thereof can be used.

Ester diols of the cited molecular weight range such as α-hydroxybutyl-ε-hydroxyhexanoic acid ester, ω-hydroxyhexyl-γ-hydroxybutyric acid ester, adipic acid-(β-hydroxyethyl) ester or terephthalic acid-bis(β-hydroxyethyl) ester are also suitable.

Mono functional isocyanate-reaetive hydroxyl-group-containing compounds can also be used to produce the polyisocyanate prepoiymers B). Examples of such monofunctional compounds are etbanol, n-butanol, ethylene glycol monobutyl ether, diethylene glycol monomethyl ether, diethylene glycol monobutyl ether, propylene glycol monomethyl ether, dipropylene glycol monomethyl ether, tripropyiene glycol monomethyl ether, dipropylene glycol monopropyl ether, propylene glycol monobutyl ether, dipropylene glycol monobutyl ether, tripropyiene glycol monobutyl ether, 2-ethylhexanol, 1-octanol, 1-dodecanol or 1-hexadecanol or mixtures thereof.

To produce the polyisocyanate prepolymers B) diisocyanates can preferably be reacted with the polyols in a ratio of isocyanate groups to hydroxyl groups (NCO/OH ratio) of 2:1 to 20:1, for example 8:1. Urethane and/or allophanate structures can be formed in this process. A proportion of unreacted polyisocyanates can be separated off subsequently, A film distillation process can be used to this end, for example, wherein low-residual-monomer products having residual monomer contents of for example ≦1 percent, by weight, preferably ≦0.5 percent by weight, particularly preferably ≦0.1 percent by weight, are obtained. The reaction temperature can be from 20° C. to 120° C., preferably from 60° C. to 100° C. Stabilisers such as benzoyl chloride, isophthaloyl chloride, dibutyl phosphate, 3-chloropropionic acid or methyl tosylate can optionally be added during production.

Furthermore, NH₂- and/or NH-functional components can additionally be used for chain extension during production of the polyisocyanate prepolymers B),

Suitable components for chain extension are organic diamines or polyamines. For example, ethylene diamine, 1,2-diaminopropane, 1,3-diaminopropane, 1,4-diaminobutane, 1,6-diaminohexane, isophorone diamine, isomer mixtures of 2,2.4- and 2,4,4-trimethyl hexamethylene diamine, 2-methyl pentamethylene diamine, diethylene triamine, diaminodicyclohexyl methane or dimethyl ethylene diamine or mixtures thereof can be used.

Moreover, compounds which in addition to a primary amino group also have secondary amino groups or which in addition to an amino group (primary or secondary) also have OH groups, can also be used to produce the polyisocyanate prepolymers B). Examples thereof are primary/secondary amines such as diethanolamine, 3-amino-1-methylaminopropane, 3-arnino-1-ethylaminopropane, 3-amino-1-cyclohexylaminopropane, 3-amino-1-methylaminobutane, alkanol amines such as N-aminoethyl ethanoiamine, ethanolamine, 3-aminopropanol, neopentanolamine. Amines having an isocyanate-reactive group, such as methylamine, ethylamine, propylamine, butylamine, octylamine, laurylamine, stearylamine, isononyl oxypropylamine, dimethylamine, diethylamine, dipropylamine, dibutylamine, N-methylaminopropylamine, diethyl(methyl)aminopropylamine, niorpholine, piperidine, or suitable substituted derivatives thereof, ainidoamines of diprimary amines and monocarboxylic acids, monoketimines of diprimary amines, primary/tertiary amines, such as N,N-dimethylaminopropylamine, are conventionally used for chain termination.

The polyisocyanate prepolymers or mixtures thereof used as component B) can preferably have an average NCO functionality of 1.8 to 5, particularly preferably 2 to 3.5, and most particularly preferably 2 to 3.

Component C) is a compound having at least two isocyanate-reactive functional groups. For example, component C) can be a polyamine or a polyol having at least two isocyanate-reactive hydroxyl groups.

Hydroxy-functional, In particular polymeric, polyols, for example polyether polyols or polyester polyols, can be used as component C). Suitable polyols have already been described above in connection with the production of prepolymers B), reference to which is made in order to avoid repetition.

It Is preferable for component C) to be a polymer having 2 to 4 hydroxyl groups per molecule, most particularly preferably a polypropylene glycol having 2 to 3 hydroxyl groups per molecule.

It is favourable if the polymeric polyols C) have a particularly narrow molecular weight distribution, in other words a polydispersity (PD=M_{w}/Mₙ) of 1.0 to 1.5. Polyether polyols for example preferably have a polydispersity of 1.0 to 1.5 and an OH functionality of greater than 1.9 and particularly preferably greater than or equal to 1.95.

Such polyether polyols can be produced in a manner known per se by alkoxylation of suitable starter molecules, in particular using double metal cyanide catalysts (DMC catalysis). This method is described for example in the patent U.S. Pat. No. 5,158,922 and in the laid-open patent application EP 0 654 302 A1.

The reaction mixture for the polyurethane can be obtained by mixing components A) and/or B) and C). The ratio of isocyanate-reactive hydroxyl groups to free isocyanate groups here is preferably from 1:1.5 to 1.5:1, particularly preferably from 1:1.02 to 1:0.95.

At least one of components A), B) or C) preferably has a functionality of ≧2.0, preferably ≧2.5, preferably ≧3.0, in order to introduce a branching or crosslinking into the polymer element. The term “functionality” refers in components A) and B) to the average number of NCO groups per molecule and in component C) to the average number of OH, NH or NH₂ groups per molecule. This branching or crosslinking brings about better mechanical properties and better elastonieric properties, in particular also better strain properties.

The polyurethane polymer obtained from the printing ink can preferably have a maximum stress of ≧0.2 MPa, in particular 0.4 MPa to 50 MPa, and a maximum strain of ≧100%, in particular ≧120%. In the strain range of 50% to 200% the polyurethane can moreover have a stress of 0.1 MPa to 1 MPa, for example 0.1 MPa to 0.8 MPa, in particular 0.1 MPa to 0.3 MPa (detennined in accordance with ASTM D 412). Furthermore the polyurethane can have a modulus of elasticity at a strain of 100% of 0.1 MPa to 30 MPa, for example 20 MPa to 27 MPa (determined in accordance with ASTM D 412).

The polyurethane polymer obtained from the printing ink is preferably a dielectric elastomer having a specific electrical volume resistivity in accordance with ASTM D 257 of ≧10¹² to ≦10¹⁷ Ohm cm. It is further preferable for the polyurethane polymer to have a dielectric constant in accordance with ASTM 150-98 of ≧5 to ≦10 and a dielectric breakdown field strength in accordance with ASTM 149-97a of ≧100 V/μm to ≦200 V/μm. A maximum dielectric constant is desirable in principle in order to optimise the serviceability of the polymer.

In addition to components A), B), C) and D), the printing ink can additionally also contain auxiliary substances and additives. Examples of such auxiliary substances and additives are crosslmkers, thickeners, solvents, thixotropic agents, coupling agents, stabilisers, antioxidants, light stabilisers, ernulsiiiers, surfactants, adhesives, plasticisers, hydrophobing agents, pigments, fillers and flow control agents. Preferred solvents are methoxypropyl acetate and ethoxypropyl acetate. Preferred flow control agents are poiyacrylates, in particular amine resin-modified acrylic copolymers.

Fillers can regulate the dielectric constant of the polymer element, for example. The reaction mixture preferably includes fillers to increase the dielectric constant, such as fillers having a high dielectric constant. Examples thereof are ceramic fillers, in particular barium titanate, titanium dioxide and piezoelectric ceramics such as quartz or lead zirconium titanate, as well as organic fillers, in particular those having a high electrical polarising capacity, for example phthalocyanines.

A high dielectric constant can also be achieved by the introduction of electrically conductive fillers below the percolation threshold. Examples are carbon black, graphite, single-walled or multi-walled carbon nanotubes, electrically conductive polymers such as polythiophenes, polyanilines or polypyrroles, or mixtures thereof. Carbon black types which exhibit surface passivation and which thus in low concentrations below the percolation threshold increase the dielectric constant yet do not lead to an increase in the conductivity of the polymer are of particular interest in this context.

It should be noted that the term “a” in connection with the present invention and in particular with components A), B) and C) is used not as a numeral but as an indefinite article, unless the context clearly indicates a different interpretation.

Embodiments of the method according to the invention are described below, wherein the individual embodiments can be combined with one another in any way.

In an embodiment of the method according to the invention the printing ink is applied as a layer in a layered composite. In this way inter alia a dielectric elastomer in contact with electrodes on both sides can be obtained. The short curing times means that the process of pressing multiple layers on top of one another is also effective.

In a further embodiment of the method according to the invention the content of free isocyanate groups in the printing ink on application is ≧50% to ≦100%, based on the original content of components A) and/or B). The decrease in the content of NCO groups can be monitored by means of IR spectroscopy, for example. The content can also be ≧60% to ≦90% or ≧70% to ≦80%. With the cited content of NCO groups the printing ink can also be used together with very fine screens without too extensive a curing of the polyurethane causing the viscosity of the printing ink to rise too high.

In a further embodiment of the method according to the invention, after application of the printing ink it is heated up to a temperature of from ≧30° C. to ≦150° C. for a period of time of from ≧1 second to ≦10 minutes. The period of time can also be ≧30 seconds to ≦8 minutes or ≧1 minute to ≦5 minutes. The heating-up temperature can also be ≦40° C. to ≦120° C. or ≧50° C. to ≦100° C. These embodiments of the thermal curing of the polyurethane lead to very effective printing processes. Heating preferably takes place in a drying oven and particularly preferably in a tunnel dryer.

In a further embodiment of the method according to the Invention the polyisocyanate A) is a biuret of an aliphatic polyisocyanate. It is preferably the Afunctional biuret of 1,6-hexamethylene diisocyanate.

In a further embodiment of the method according to the invention the polyisocyanate prepolymer B) is a prepolymer which is obtainable from the reaction of a trifunctional polypropylene glycol polyether with diphenylmethane diisocyanate (MDI) and/or bexamethylene diisocyanate (HDI). It is furthermore also possible for a difunctional polypropylene glycol-polyethylene glycol-polyether polyol to be used in addition to the trifunctional polyol in the reaction mixture leading to the prepolymer. The molecular weight Mₙ of the aforementioned trifunctional polyol is preferably in a range from ≧5800 g/mol to ≦6200 g/mol and that of the aforementioned difunctional polymer in a range from ≧1.800 g/mol to ≦2200 g/mol.

The trifunctional polyol for producing the prepolymer A) preferably has a polydispersity index Mw/Mn of ≧1.0 to ≦1.1. The polydispersity index can be determined by gel permeation chromatography (GPC) against a polystyrene standard. It too is preferably in a range from ≧1.0 to ≦1.08 or ≧1.0 to ≦1.05. Such a uniform polyol structure helps to produce a regular polyurethane polymer.

In a further embodiment of the method according to the invention the compound C) which is reactive towards isocyanate groups is a polyester polyoi which is obtainable from the reaction of adipic acid with hexanediol. It is furthermore also possible for neopentyl glycol to be used in addition to hexanediol in the reaction mixture leading to the polyol.

In a further embodiment of the method according to the invention the thermally activatable catalyst D) comprises tin, titanium, zirconium and/or hafnium.

According to an extension of the above embodiment the catalyst D) which can be activated by increasing the temperature comprises a Zr-chelate complex. Surprisingly it has been found that these catalysts, which are designed more for aqueous systems, are also suitable for the method according to the invention.

In a further embodiment of the method according to the invention the catalyst D) is employed in a content of from ≧0.0003 % by weight to ≦0.009 % by weight, based on the titanium, zirconium and hafnium content of the total weight of the printing ink. This content is preferably ≧0.0006 % by weight to ≦0.0075 % by weight and more preferably ≧0.0015 % by weight to ≦0.006 % by weight. Such catalyst amounts increase the effectiveness of a screen printing process in the manner described according to the invention, without having a detrimental effect on the function of a dielectric elastomer.

Conventional commercially obtainable catalyst preparations can be employed for example in a content of from ≧0.01 % by weight to ≦0.3 % by weight, based on the total catalyst preparation content of the total weight of the printing ink. This content is preferably ≧0.02 % by weight to ≦0.25 % by weight and more preferably ≧0.05 % by weight to ≦0.2 % by weight.

Based on the zirconium content, for example, the specified amounts mean a content of from ≧0.0003 % by weight to ≦0.009 % by weight of the total weight of the printing ink.

The present invention also provides the use of a reaction mixture which comprises
a polyisocyanate A) and/or
a polyisocyanate prepolymer B),
an at least difunctional compound C) which is reactive towards isocyanate groups
and furthermore a catalyst D) which can be activated by increasing the temperature
   as a printing ink in screen printing methods.

With regard to the details of the use according to the invention, reference is made to the embodiments of the method. The same applies to the embodiments described below, which in turn can be combined with one another in any way. Embodiments not explicitly mentioned below, which however have been described in connection with the method according to the invention, are likewise included in the framework of the present invention with regard to the use.

In an embodiment of the use according to the invention the polyisocyanate A) is a biuret of an aliphatic polyisocyanate. It is preferably the trifunctional biuret of 1,6-hexamethylene diisocyanate.

In a further embodiment of the use according to the invention the polyisocyanate prepolymer B) is a prepolymer which is obtainable from the reaction of a trifunctional polypropylene glycol polyether with diphenylmethane diisocyanate (MDI) and/or hexamethylene diisocyanate (HDI). It is furthermore also possible for a difunctional polypropylene glycol-polyethylene glycol-polyether polyol to be used in addition to the trifunctional polyol in the reaction mixture leading to the prepolymer. The molecular weight Mn of the aforementioned trifunctional polyol is preferably in a range from ≧5800 g/mol to ≦6200 g/mol and that of the aforementioned difunctional polymer in a range from ≧1800 g/mol to ≦2200 g/mol.

The trifunctional polyol for producing the prepolymer A) preferably has a polydispersity index Mw/Mn of ≧1.0 to ≦1.1. The polydispersity index can be determined by gel permeation chromatography (GPC) against a polystyrene standard. It too is preferably in a range from ≧1.0 to ≦1.08 or ≧1.0 to ≦1.05. Such a uniform polyol structure helps to produce a regular polyurethane polymer.

In a further embodiment of the use according to the invention the compound C) which is reactive towards isocyanate groups is a polyester polyol which is obtainable from the reaction of adipic acid with hexanediol. It is furthermore also possible for neopentyl glycol to be used in addition to hexanediol in the reaction mixture leading to the polyol.

In a further embodiment of the use according to the invention the catalyst D) comprises tin, titanium, zirconium and/or hafnium, particularly preferably a Zr-chelate complex.

In this case the catalyst can fuilhermore be employed in a content of from ≧0.0003 % by weight to ≦0.009 % by weight, based on the titanium, zirconium and hafnium content of the total weight of the printing ink. This content is preferably ≧0.0006 % by weight to ≦0.0075 % by weight and more preferably ≧0.0015 % by weight to ≦0.006 % by weight, Such catalyst amounts increase the effectiveness of a screen printing process in the mariner described according to the invention, without having a detrimental effect on the function of a dielectric elastomer.

Conventional commercially obtainable catalyst preparations can be employed for example in a content of from ≧0.01 % by weight to ≦0.3 % by weight, based on the total catalyst preparation content of the total weight of the printing ink. This content is preferably ≧0.02 % by weight to ≦0.25 % by weight and more preferably ≧0.05 % by weight to ≦0.2 % by weight.

A most particularly preferred formulation for the method according to the invention and for the use according to the invention comprises the following components, each specified with no further solvent contents:

| Component | Weight % |
|---|---|
| Hexamethylene diisocyanate biuret, trimer | ≧20 to ≦30 |
| Polyester polyol | ≧30 to ≦40 |
| Zr-chelate complex catalyst | ≧0.0003 to ≦0.009 |
| | (Zr content) |

The present invention likewise relates to an electromechanical converter comprising a polymer layer produced by a method according to the invention. The polymer layer is preferably part of a layered composite which is constructed in such a way that this layer containing the polyurethane polymer is at least partially in contact on both sides with electrode layers. The layered composite according to the invention can then function as a dielectric elastomer in contact on both sides.

The thickness of the dielectric elastomer layer is preferably ≧1 μm to ≦500 μm, more preferably ≧20 μm to ≦200 μm and even more preferably ≧30 μm to ≦150 μm. It can be constructed from one piece or from a plurality of pieces. For example, a multi-piece layer can be obtained by pressing individual layers on top of one another.

If a mechanical load is applied to such a converter, the converter deforms along its thickness and its surface, for example, and a strong electrical signal can be detected at the electrodes. Mechanical energy is converted into electrical energy in this way. The converter according to the invention can thus be used both as a generator and as a sensor.

By making use of the opposite effect, namely the conversion of electrical energy into mechanical energy, the converter according to the invention can on the other hand equally serve as an actuator.

Possible uses of such an electromechanical converter include a large number of diverse applications in the electromechanical and electroacoustlcal area, in particular in the area of energy recovery from mechanical vibrations and periodic movements in general (known as energy harvesting), acoustics, ultrasound, medical diagnostics, acoustic microscopy, mechanical sensors, in particular pressure, force and/or strain sensors, robotics and/or communication technology. Typical examples include pressure sensors, electroacoustical converters, microphones, loudspeakers, vibration converters, light deflectors, membranes, modulators for glass fibre optics, pyroelectric detectors, capacitors and control systems and “intelligent” floors.

The present invention is illustrated in more detail by the example below, without however being restricted thereto.

### EXAMPLE

A screen printing ink for use according to the invention was produced according to the formulation below:

| Component | Weight % |
|---|---|
| Desmodur ® N 75 MPA (75% in 1-methoxypropyl acetate-2) | 32.05 |
| (hexamethylene diisocyanate biuret, trimer, Bayer MaterialScience) | |
| Desmophen ® 670 (80% in ethoxypropyl acetate) | 44.55 |
| (polyester polyol, Bayer MaterialScience) | |
| Additol ® XL480 50% in butoxyl | 0.96 |
| (amine resin-modified acrylic copolymer, Cytec) | |
| K-Kat ® A209 | 0.20 |
| (Zr-chelate complex, solution in t-butyl acetate, 14% chelate complex content, | |
| available from King Industries, | |
| http://www.kingindustries.com/PDFS/KKAT%20TDS_PG13/Kkat_A209.pdf) | |
| Ethoxypropyl acetate | 22.40 |

The catalyst was adjusted for processing of the polyurethane component specified in the example by screen printing. The concentration used enabled the reaction between polyoi (Desmophen 670) and isocyanate (Desrnodur N75) at elevated temperature in a dryer to be accelerated. At the same time the catalyst concentration used did not excessively restrict the pot life, such that the catalysed system remained processable for approximately 30 minutes without having a detrimental effect on the function of the dielectric elastomer layer.

The polyurethane curing time was reduced from approximately 20 minutes without catalysis to five minutes. The effectiveness of the production process was increased in this way. A drying time of five minutes simplifies the use of tunnel dryers, as the drying section can be shorter or, in the case of longer dryers, the belt speed can be raised, increasing the hourly output. At fast belt speeds a drying time of the uncatalysed system of twenty minutes requires a very long section in the belt dryer.

If dryers of a suitable length were unavailable, investment costs would have to be incurred, otherwise a time-consuming batch drying has to be carried out in a drying cabinet. If the belt speed is set very low in order to achieve the long drying time even in shorter belt dryers, the printing process also becomes slower, as drying then becomes the speed-determining step. At slow belt speeds of one metre per minute, a drying time of twenty minutes would require a drying section of twenty metres at 110° C., Preheating and cooling zones are also necessary,

The ink from the example was applied to a substrate by screen printing and thermally cured for five minutes in a drying cabinet at 110° C. The polyurethane elastomer obtained in this way had the following properties:

| Specific electrical volume | 2.3 · 10¹⁵ | Ω cm | (ASTM D 257) |
|---|---|---|---|
| resistance: | | | |
| Dielectric constant: | 8.5 | | (ASTM 150-98) |
| Dielectric breakdown field | 135 | V/μm | (ASTM 149-97a) |
| strength: | | | |
| Maximum system strain: | 120% | | (ASTM D 412) |
| E modulus at 50% deformation: | 7.3 | MPa | (ASTM D 412) |
| E modulus at 100% deformation: | 26 | MPa | (ASTM D 412) |

The electrical volume resistance was determined using a measurement setup from Keith fey Instruments in accordance with the above standard. Furthermore, the system strain at break was determined using a Zwick tensile testing machine on a self-supporting layer in accordance with the corresponding standard and the moduli of elasticity from the stress-strain curve as a tangent. The breakdown field strength was determined using a proprietary measurement setup in accordance with the above standard.

1. Method for printing objects, comprising the step of application of a printing ink by means of screen printing,
characterized in that
the printing ink comprises
a polyisocyanate A) and/or
a polyisocyanate prepolymer B),
an at least difunctional compound C) which is reactive towards isocyanate groups
and furthermore a catalyst D) which can be activated by increasing the temperature.

2. Method according to claim 1,
characterized in that
the printing ink is applied as a layer in a layered composite.

3. Method according to claim 1 or 2,
characterized in that
the content of free isocyanate groups in the printing ink on application is ≧50% to ≦100%, based on the original content of components A) and/or B).

4. Method according to one of claims 1 to 3,
characterized in that
after application of the printing ink, this is heated up to a temperature of from ≧30° C. to ≦150° C. for a period of lime of from ≧1 second to ≦10 minutes.

5. Method according to one of claims 1 to 4,
characterized in that
the polyisocyanate A) is a biuret of an aliphatic diisocyanate.

6. Method according to one of claims 1 to 5,
characterized in that
the polyisocyanate prepolymer B) is a prepolymer which is obtainable from the reaction of a trifunctional polypropylene glycol polyether with diphenylmethane-diisocyanate and/or hexamethylene-diisocyanate.

7. Method according to one of claims 1 to 6,
characterized in that
the compound C) which is reactive towards isocyanate groups is a polyester polyol which is obtainable from the reaction of adipic acid with hexanediol.

8. Method according to one of claims 1 to 7,
characterized in that
the thermally activatable catalyst D) comprises tin and/or titanium and/or zirconium and/or hafnium.

9. Method according to claim 8,
characterized in that
the catalyst D) comprises a Zr-chelate complex.

10. Method according to claim 8,
characterized in that
the catalyst D) is employed in a content of from ≧0.0003 % by weight to ≦0.009 % by weight, based on the titanium, zirconium and hafnium content of the total weight of the printing ink.

11. Use of a reaction mixture which comprises
a polyisocyanate A) and/or
a polyisocyanate prepolymer B),
an at least difunctional compound C) which is reactive towards isocyanate groups
and furthermore a thermally activatable catalyst D),
as a printing ink in screen print-trig processes.

12. Use according to claim 11,
characterized in that
the polyisocyanate A) is a biuret of an aliphatic polyisocyanate, and/or
the polyisocyanate prepolymer W) is a prepolymer which is obtainable from the reaction of a trifunctional polypropylene glycol polyether with diphenylmethane-diisocyanate and/or hexamethylene-diisocyanate, and/or
the compound C) which reactive towards isocyanate groups is a polyester polyol which is obtainable from the reaction of adipic acid with hexanediol and/or
the catalyst D) comprises tin, titanium, zirconium and/or hafnium.

13. Use according to claim 12,
characterized in that
the catalyst D) comprises a Zr-chelate complex.

14. Electromechanical converter comprising a polymer layer produced by a method according to one of claims 1 to 10.
